(19) United States
(12) Patent Application Publication
(10) Pub. No.: US 2007/0113243 A1
(43) Pub. Date: May 17, 2007

(54) Targeted advertising system and method

(76) Inventor: Thomas A. Brey, Lake in the Hills, IL (US)

Correspondence Address: MOTOROLA, INC., 1303 EAST ALGONQUIN ROAD, IL01/3RD, SCHAUMBURG, IL, 60196, US

(21) Appl. No.: 11/281,284

(22) Filed: Nov. 17, 2005

(51) Int. Cl. H04N 7/173; H04N 7/16; H04N 7/10; H04N 7/025

(52) U.S. Cl. 725/32; 725/135; 725/100

(57) ABSTRACT

A targeted advertising system comprising an interface unit (110) configured to receive broadcast transmissions, a primary broadcast stream (101) for broadcast programming, a secondary broadcast stream (105) for targeted advertising content, and a storage device (115) for storing the targeted advertising content. The method comprises presenting a targeted advertising content to a user including receiving a primary broadcast stream (101), receiving a secondary broadcast stream (105), storing a portion of the secondary broadcast stream in a storage device (115), and presenting a targeted advertising stream to the user, which may be selected based on a user parameter.

### FIELD OF THE INVENTION

This invention relates to transmitting content in broadcast transmissions. In particular, this invention relates to transmitting targeted advertising information in a broadcast transmission.

### BACKGROUND OF THE INVENTION

Consumers have access to multiple avenues of broadcast media. Users may access broadcast programming through television (via over the air, cable, or satellite transmissions), radio (through over the air, Internet, or satellite systems such as Sirius), or prepared content distributed on media such as CDs or DVDs. Consumers may view or hear broadcast programming at home or in vehicles. Current technologies in the vehicle allow conventional radio broadcasts, satellite radio broadcasts, or even WiFi or WiMax transmissions of Internet data streams.

Current advertising mechanisms known in the art are directed at targeting broadcast audiences over television and radio, Internet, and print media. Broadcast media are by definition targeted to a wide range of demographics, preferences, income levels, and consumer backgrounds. Advertising may become therefore very cost ineffective to reach specific target audiences. Broadcast media may be able to target a specific region, or specific audience that tunes in or subscribes to a particular channel or print vehicle. Current broadcast advertising mechanisms, however, are incapable of targeting audiences down to individual levels or even moderately segmented audience demographic groups.

### BRIEF DESCRIPTION OF THE DRAWINGS

Embodiments of the present invention are now described, by way of example only, with reference to the accompanying figures in which:

FIG. 1 illustrates a targeted advertising system;

FIG. 2 illustrates a targeted advertising system in a vehicle environment;

FIG. 3 illustrates the targeted advertising system of FIG. 1 where a commercial break is indicated in the primary broadcast;

FIG. 4 illustrates acts to present an advertising stream to a targeted user during a commercial break using the advertising system of FIG. 1;

FIG. 5 illustrates acts to present an advertising stream to a targeted user based on user profiles stored in the advertising system; and

FIG. 6 illustrates acts to provide feedback from a user of the targeted advertising system to the broadcast system.

### DETAILED DESCRIPTION OF THE INVENTION

The invention provides a targeted advertising system for transmitting a broadcast stream that can be targeted to specific user preferences and demographic characteristics. The system may include an interface unit, a primary broadcast stream, a secondary broadcast stream containing a targeted user presentation stream (such as targeted advertising streams), and a storage device for storing portions of the targeted advertising streams. The system may be configured to load and/or store user profiles to allow selection of the targeted advertising based on the user's profile. The system may also be configured to allow the user to provide feedback to a broadcaster or advertiser, allowing customization and tailoring of the broadcast stream.

The invention also provides a method for presenting targeted advertising to a user. The method may include receiving primary and secondary broadcast streams, storing a portion of the secondary broadcast stream, and presenting the portion of the secondary broadcast stream to the user/viewer based on stored user preferences and demographics profiles. The method may also allow the user to provide feedback on the advertisements to the broadcaster or advertiser. Let us now refer to the figures that illustrate embodiments of the present invention in detail.

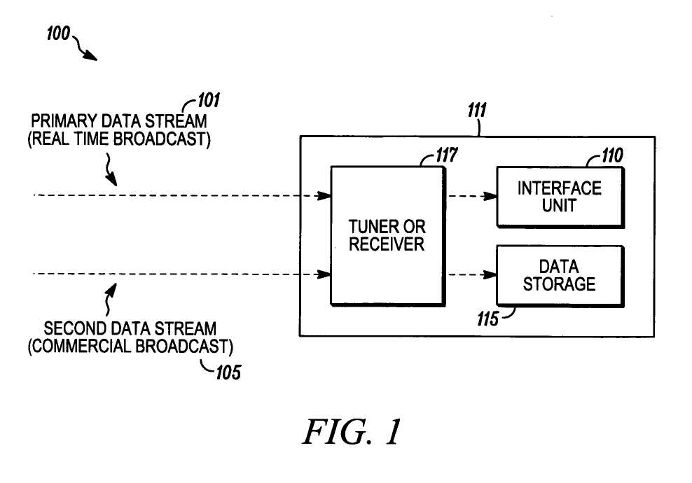

FIG. 1 depicts an example of a targeted advertising system 100 in accordance with the present invention. The system 100 could be embodied in any type of device (e.g., mobile, portable, or stationary) for use in any type of environment (e.g., for use in a vehicle, for use in a home, or the like). The system 100 may include a primary broadcast stream 101, a secondary broadcast stream 105, and a receiver unit 111. The receiver unit 111 may include an interface unit 110, a tuner and/or receiver device 117 and a storage device 115. The tuner and/or receiver device 117 may integrate directly with the interface unit 110 or may function as a separate unit. The primary broadcast stream 101 may include a standard broadcast stream and may be transmitted and received in real time. The primary broadcast stream 101 may contain audio and/or video content as well as data streams, such as Internet Protocol (IP) packets, cellular, WiFi, radio-frequency, or other data sources in combination with audio and/or video or provided separately. The primary broadcast stream 101 may also be digital high definition (HD) broadcast, digital or analog radio, satellite TV or radio and cable. The primary broadcast stream 101 may be buffered in whole or in part by the storage device 115, or the primary broadcast stream 101 may be processed by the interface unit 110 or the tuner/receiver 117. Such processing may include conditioning, filtering, and/or buffering as typically known in the art.

The secondary broadcast stream 105 may be continually broadcast and stored in memory in whole or in part in the storage device 115. The secondary broadcast stream 105 may include targeted user presentation streams, such as targeted advertising, for presentation to a user of the system. The targeted user presentation streams may be standard broadcast commercial content or may be commercial advertising content targeted to specific demographic segments of the population. The secondary broadcast stream 105 may contain audio and/or video content as well as data streams, such as Internet Protocol (IP) packets, cellular, WiFi, radio-frequency, or other data sources in combination with audio and/or video or provided separately. If the interface unit 110 is configured to present a targeted user presentation stream contained in the secondary broadcast stream 105, such as targeted advertising, the targeted user presentation stream may be presented during the commercial break. If the interface unit 110 is not configured to present the targeted user presentation stream, the standard commercial content may be presented during a commercial break. The secondary broadcast stream 105 may be broadcast in the same formats as the primary broadcast stream 101, such as digital HD broadcast, digital or analog radio, satellite TV or radio and cable. Both the primary broadcast stream 101 and the secondary broadcast stream 105 may be delivered and presented in real-time, or in a time-delayed manner after storage in the storage device 115 or other buffer present in the system. Both the primary broadcast stream 101 and the secondary broadcast stream 105 may include one or more channels of broadcast or targeted advertising content, respectively, and the channels may be selected for independent presentation to the user. Moreover, the broadcaster of the primary broadcast stream may be the same or different from the broadcaster of the secondary broadcast stream. Further, the secondary broadcast stream may comprise content from a plurality of different broadcasters/advertisers.

The interface unit 110 may include a tuner/receiver 117 configured to receive, decode, and present digital HD broadcast, digital or analog radio, satellite TV or radio broadcasts. Examples of an interface unit 110 includes television cable boxes, television antenna receiver units, satellite television receiver units, vehicle radio and/or entertainment units, vehicle telematics units (such as a vehicle navigation or “infotainment” unit such as a head unit or in-dash information interface and display provided in a vehicle), vehicle satellite radio receiver units, desktop computers, laptop computers, and portable entertainment units, cellular phones, handsets, or portable electronic devices like personal digital assistants. The interface unit 110 may comprise display devices, audio output devices, human-machine interfaces, such as haptic/touch screen interfaces, and/or voice recognition functionality. The interface unit 110 may also comprise navigation, routing, personal information, planning, or entertainment applications in addition to broadcast media presentation capabilities. The storage device 115 comprises some type of memory capability such as volatile or flash memory, non-volatile memory, re-writable disk-storage media such as CD's or DVD's, and/or hard disk storage media. The storage device 115 may integrate with the interface unit 110 or may be housed separately.

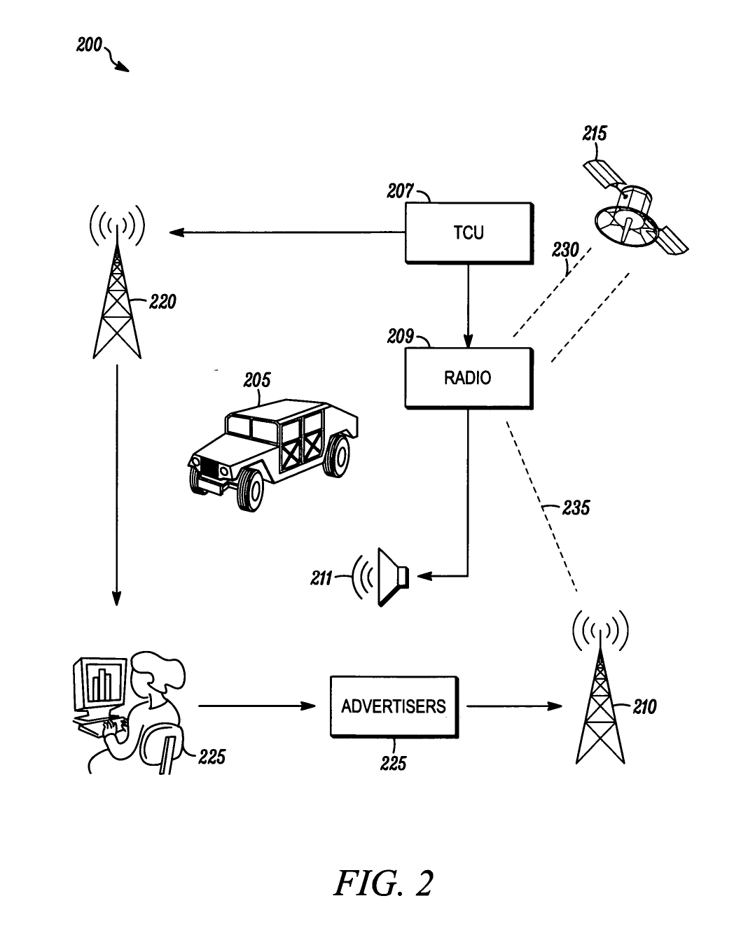

FIG. 2 illustrates an example of a targeted advertising system 200 for use in a vehicle environment. The advertising system 200 may include a vehicle 205, a ground based broadcast transmitter 210, a satellite broadcast transmitter 215, a cellular ground network 220, and an advertising feedback network 225 external to the vehicle. The vehicle 205 may incorporate a telematics control unit (TCU), such as a telematics interface unit 207 and an information/entertainment unit 209, such as a radio. The information/entertainment unit 209 may include output devices 211, such as speakers and/or graphic display units.

The interface unit 207 may interact with the cellular ground network 220 to transmit feedback information to the advertising feedback network 225. The interaction may allow the advertising feedback network 225 to better tailor advertising in broadcasts, such as advertising contained in the secondary broadcast stream 105, for particular demographics or users. The interface unit 207 may also receive satellite broadcast transmissions 230 from either the satellite broadcast transmitter 215 or ground-based broadcast transmissions 235 from the ground-based broadcast transmitter 210, or from both. Either the satellite transmitter 215 or the ground based transmitter 210 may receive information from the advertising feedback network 225 to transmit to the interface unit 207 and information/entertainment unit 209 for presentation to a user in the vehicle 205.

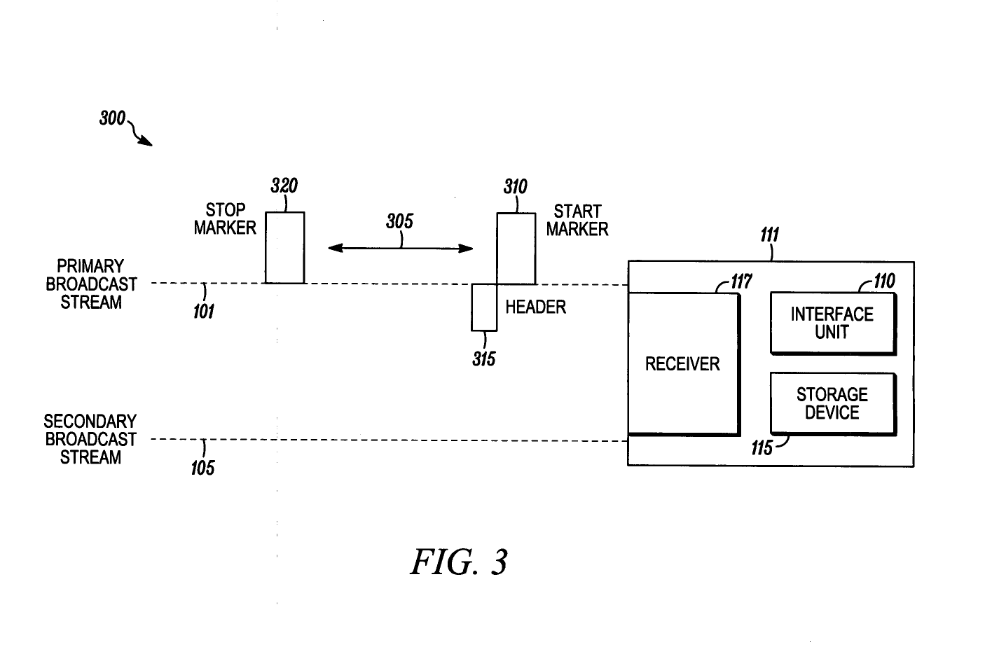

FIG. 3 illustrates an example of a broadcast sequence that the system 100 or 200 may implement. In an embodiment of the present invention, during the standard broadcast transmission, a commercial break period is inserted into the primary broadcast stream 101. When the primary broadcast stream 101 (or standard broadcast) goes into a commercial break 305, the broadcaster transmits a start marker 310 at the beginning of the commercial break 305. The start marker 310 triggers the system 100 to start playing a commercial which may be stored in the storage device 115. Viewers or listeners with compatible equipment are exposed to targeted user presentation streams, such as targeted demographic commercials that are streamed from the storage device 115. Viewers or listeners with incompatible equipment, however, may hear and/or see the standard set of commercials that are being broadcast during the timeslot. At the end of the commercial break 305, a stop marker 320 is transmitted. The stop marker 320 triggers the system 100 to resume presentation of the standard broadcast of the primary broadcast stream 101 again.

When the system 100 is presenting a targeted user presentation stream (i.e., in commercial mode), the targeted user presentation stream may be streamed from the storage device 115. These targeted user presentation streams, such as targeted commercials, are chosen based on user parameters, such as user demographics. For example, the system 100 may store, in the storage device 115, a commercial that meets the consumer's tailored demographics, such as the consumer's sex, age, region of the country, or other classification. The commercials may also be set to rating preferences. The ratings preferences preserve memory within the storage device 115. In another example, the system 100 may store, in the storage device 115, all commercials, but only present commercials that meet the user's tailored demographics. Commercials may be rated by a user so that commercials that do not meet the user's criteria for acceptability may not be played. By having the ability to set rating standards, the user may prevent objectionable or undesirable commercials from playing on the system 100. An advertiser may still be able to deliver an alternate commercial that is more acceptable to the user. The advertiser may have several commercial broadcasts targeting several target demographics.

Within the designated commercial break 305, there may be several commercials run simultaneously. The broadcaster may identify what types of commercials the system 100 should play by placing a header 315 at the start of each timeslot. The header 315 may identify the identity of the broadcaster and the sponsor that should be played. For example, one advertiser may want to run its advertisement in the 12:00 PM timeslot to all listeners receiving the primary broadcast stream 101. The header 315 would designate to the system 100 to start streaming that advertiser's advertisement. The user would receive a targeted user presentation stream, that had been received in the secondary broadcast stream 105 and downloaded to the storage device 115, where the targeted user presentation stream matched the user's particular demographic.

By using targeted advertising, a broadcaster may be able to fit more advertisements in a given time slot. For example, a candidate for a political office may purchase a commercial timeslot hoping to reach a target audience. The uncertainty of broadcast advertising leaves in doubt what percentage of the target audience actually paid attention to the advertisement and what percentage did not relate to the issues presented. If that same timeslot was used to trigger a set of targeted advertisements, the commercials played could be more specifically chosen to fit the user's demographics. The candidate may now deliver a more effective message to the listener/viewer within the same time slot. The broadcaster may also be able to collect more advertising revenue for this service.

The start marker 310 identifies the start of a commercial break 305 as well as the station that is currently being received on the primary broadcast stream 101. The stop marker 320 identifies the end of the commercial break 305. The time slot header 315 is positioned at the start of each commercial timeslot. The time slot header 315 may be used to identify what types of commercials should be played during a timeslot. Other information may be added as needed, such as station identification, emergency broadcast information, weather conditions, or traffic alerts, just to name a few.

In the case of satellite radio, for example, users that pay for a premium service may continue to hear the broadcasted music, while free subscribers would hear the commercials. The interface unit 110 may be used as a key feedback channel and collection point. Examples of feedback information may comprise which commercials were played and how many times. New demographic information or the consumer's response to a particular commercial may also be collected via a voting button on the radio or other input interfaces. The information may then be used to improve the effectiveness of the targeted commercial.

The system 100 may store one or more user profiles in the storage device 115. For example, a family of four using the vehicle 205 and interface unit 110 may have one profile for the husband, one for the wife, and maybe a family profile. The profiles could be triggered in several ways. The profiles may be preset on the radio of the vehicle 205, through car keys tagged to a user, through a key fob, through a radio-frequency identification (RFID) attached to a car key, or an RF tag reader that may scan for the presence of tags and may create a user profile based on the data the system 100 may collect. In a home environment, a user's demographics may be identified by buttons on a remote control used to control a television or entertainment device. For example, a user may set up user buttons for each family member. This button, when pressed, triggers the stored user profile. The fixed location of the home environment may allow the broadcaster and advertiser to improve the targeting of local commercial spots.

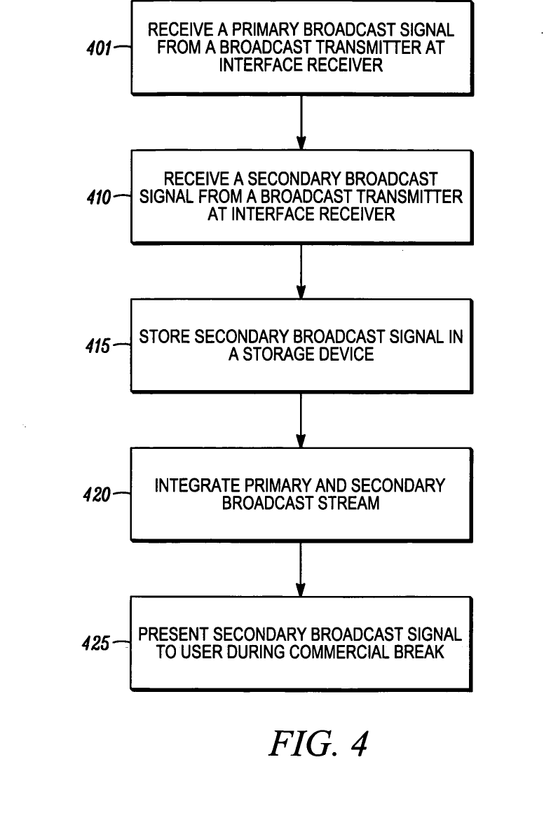

FIG. 4 illustrates an example of one embodiment of the present invention where steps are taken to deliver commercial advertising through a broadcast medium to an interface unit configured to receive the broadcast medium. The tuner/receiver 117, which may be integrated with the interface unit 110, at step 401, receives, from a broadcaster, one or more broadcast channels, each including a primary broadcast stream 101. The primary broadcast stream 101 may comprise a source of information such as news, music, weather, or other topical information broadcast over a medium. The tuner/receiver 117, at step 410, receives, from the broadcaster, one or more broadcast channels, each including a secondary broadcast stream 105. The secondary broadcast stream 105 may include advertising sequences to be presented to a user during a commercial break 305. The storage device 115, at step 415, then stores at least a portion of the secondary broadcast stream 105. The storage device 115 may also store the entire secondary broadcast stream 105, a portion(s) of the secondary broadcast stream 105, or a portion(s) of the primary broadcast stream 101. The interface unit 110, at step 420, integrates the primary broadcast stream and the secondary broadcast stream to create a targeted user presentation stream.

The interface unit 110, at step 425, then presents at least a portion of the secondary broadcast stream 105 to the user during the commercial break 305. The portions of the secondary broadcast stream 105 may include targeted user presentation streams, such as commercials targeted to specific demographics, user profiles, regional characteristics, or subscription levels obtained by the user. The secondary broadcast stream 105 may be presented in real-time, or may be stored in whole or part in the data storage 115 for later presentation. The interface unit 110 may present the targeted user presentation stream via a radio unit, television display, video display, or other information/entertainment unit, including desktop computers, laptop computers, personal digital assistants (PDAs), cellular telephones, or other portable electronic devices. The targeted advertising contained in the secondary broadcast stream 105 may include video and/or audio segments, which may be presented separately, or together on video outputs such as a graphical display and/or on audio outputs via a speaker system such as loudspeaker elements.

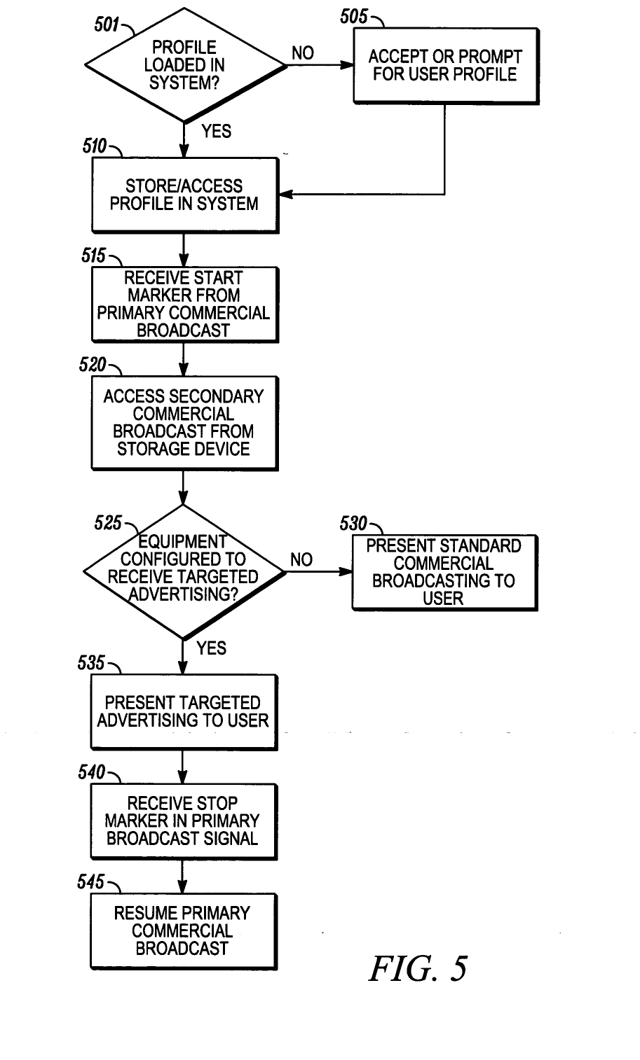

FIG. 5 illustrates another example of an embodiment of the present invention where steps are taken to present a targeted user presentation stream to a user based on user profiles associated with the system 100. The storage device 115, at step 501, determines if a profile is stored in the storage device 115. For example, if the system 100 does not have a profiled loaded for the user, the system 100, at step 505, prompts the user to enter or activate a desired profile. The system 100, at step 510, then stores at least one profile comprising at least one user parameter. Examples of user profiles include, but are not limited to, collections of user parameters for each family member, or each user of a vehicle or home entertainment unit. A user may set his or her profile based on parameters such as age, gender, interests, regional location, educational experience, ratings preferences, personal preferences, or other demographics parameters.

The system 100, at step 515, receives a start marker 310 contained within the primary broadcast stream 101, where the start marker 310 indicates a beginning of a commercial break 305 within the primary broadcast stream 101. The system 100, at step 520, triggers the interface unit 110 to access the storage device 115 to retrieve a portion of the secondary broadcast stream 105 stored in the storage device 115. The storage device 115 may be configured to store the targeted user presentation stream contained within the secondary broadcast stream 105 only if the targeted user presentation stream matches the user parameters stored in the storage device 115.

The system 100, at step 525, determines if the interface unit 110 is configured to receive targeted user presentation stream contained in the secondary broadcast stream 105. If the interface unit 110 is not capable of receiving and decoding the targeted user presentation stream, the system 100, at step 530, may present a standard commercial stream to the user. If the interface unit 110 is configured to decode the targeted user presentation stream contained in the secondary broadcast stream 105, the system 100, at step 535, presents at least one targeted user presentation stream to a user during the commercial break. The system 100, at step 540, receives a stop marker 320 contained within the primary broadcast stream 101, where the stop marker indicates an end of the commercial break within the primary broadcast stream. The system 100, at step 545, then resumes presentation of the primary broadcast stream 101 to the user after receiving the stop marker 320.

The user parameters stored in the storage device 115 may be changed during operation of the interface unit 110. A user may also select user profiles during operation of the interface unit 110. The user may select a user profile by selecting a preset button on the interface unit 110. The user may also select a user profile by communicating with-the-interface unit 110 via a wireless device. Such a wireless device may include a RFID device, a wireless key fob device, a Bluetooth enabled cellular telephone, or a wireless-enabled PDA. The user may communicate with a home entertainment unit implementing the system 100 through a remote control with buttons associated with user profiles, or the user may actuate buttons on the remote to select a user profile.

The interface unit 110 may include measures to prevent users from avoiding targeted user presentation streams that are transmitted in the secondary broadcast stream 105. For example, the interface unit 110 may prevent the user from changing a first channel to a second channel while a commercial break is in progress, where the commercial breaks lasts from the receipt of the start marker 310 until the receipt of the stop marker 320. Advertisers who may pay for the advertising content broadcast in the secondary broadcast stream 105 may not want to have their advertisements ignored or bypassed, especially considering the time and expense put into creating the targeted advertisements. If a user desires to turn off the interface unit 110, such as by turning off the vehicle to leave the vehicle, the interface unit 110 may pause the presentation of the targeted user presentation stream when the user turns off the interface unit 110 if the interface unit 110 is shut off during the commercial break. The interface unit 110 may then resume presentation of the targeted user presentation stream when the user turns the interface unit 110 on again.

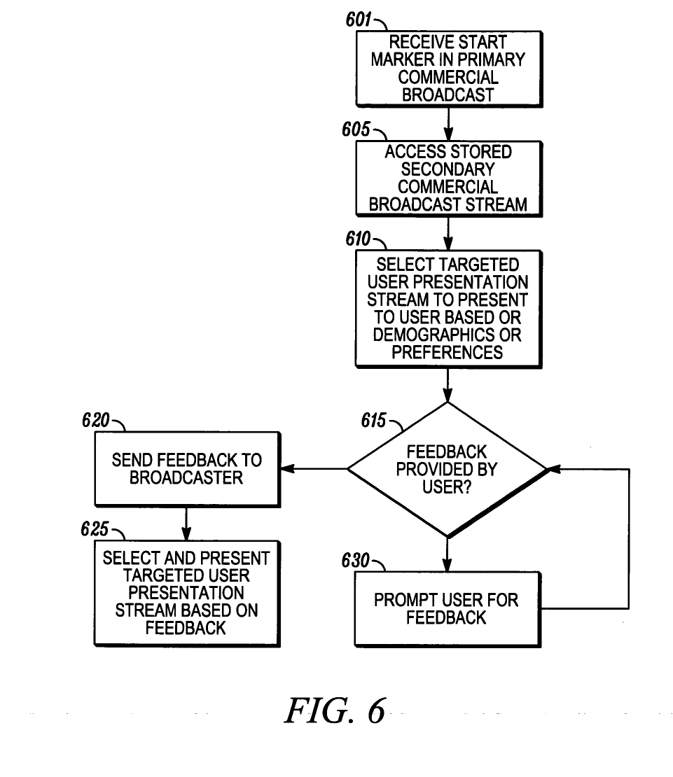

FIG. 6 illustrates another example of an embodiment of the present invention where steps are taken to provide feedback to an advertising network or broadcaster using a targeted advertising system. The feedback channel may include, but is not limited to, cable television signal, cable modem Internet transmissions, digital subscriber line (DSL) communications, radio transmissions, cellular telephone transmissions, WiFi or WiMax Internet transmissions, and other packet or switched data communications media. During normal broadcast operation of the system 100, the interface unit 110, at step 601, receives a start marker 310 in a primary broadcast stream 101, indicating the start of a commercial break 305. The interface unit 110, at step 605, accesses portions of the secondary broadcast stream stored in the storage device 115. The portions of the secondary broadcast stream 105 may include a targeted user presentation stream for presentation to the user. The interface unit 110, at step 610, selects a targeted user presentation stream to be presented to the user, based on a user profile stored in the storage device 115, such as user ratings preferences or user demographics information. The interface unit 110, at step 615, determines if any feedback has been provided by the user. The user may provide feedback by interacting with the interface unit 110 in several ways. For example, the user may select a preset button on the interface unit 110, or communicate with the interface unit 110 using a wireless device, such as a RFID device, a wireless key fob device, a Bluetooth enabled cellular telephone, or a wireless-enabled PDA. In a home entertainment environment, such as in a home television entertainment unit, the feedback information may be provided by pressing a button on a remote control device to indicate a user rating preference of the targeted user presentation stream.

If the user has provided feedback to the interface unit 110, the interface unit 110, at step 620, may send the feedback information to the broadcaster who transmitted the primary and secondary broadcast streams 101 and 105, or to an advertising feedback network 225. The interface unit 110 may also select and present a different targeted user presentation stream based on the feedback provided by the user. If the user has not provided feedback to the interface unit 110, the interface unit 110, at step 630, may prompt the user to provide feedback. The interface unit 110 may prompt for feedback using either an audible signal to the user, or through a visual indicator such a blinking signal or change in a graphical display visible to the user.

The methods for inserting targeted advertising into a broadcast stream may be configured for many different media and communication systems. Examples of media and communication systems that may be adapted for use with the targeted advertising system include, but are not limited to, satellite television and radio, cable television, terrestrial digital and analog broadcasts, digital radio, high definition radio, handset units, such as XM or Sirius handsets, cellular phones, such as cellular phones supporting streaming audio and/or video, wireless Internet transmissions such as WiFi, WiMax, and wireless cellular LAN's, DSL and cable modem transmissions, and streaming video and/or radio transmissions receivable by computer-based systems, including “Podcasts” or other streaming or downloaded content that may be viewed or heard on an electronic device.

The consumer may benefit from the targeted advertising system in several ways. The system 100 may open up several new avenues of entertainment choices to the consumer. Consumers are bombarded with much information, most of which is not relevant to the end user. By tailoring the commercial to the user's interest, advertisements themselves may be viewed more as useful information then unwanted noise. Since the system allows for instant feedback, it may trigger “flow up” information that could benefit both the end user and advertiser. For example, an advertisement for a mortgage brokerage with good rates may be played on the system. If the user is seeking to refinance his or her home mortgage, he or she may press the feedback button on the interface unit 110. This generates a message to the system that may end up at the advertiser's desk as a lead. The advertising has now generated potential business that may benefit all parties. As another example, radio/television stations could promote consumer participation by offering prize give-a-ways.

Satellite radio broadcasters may also benefit from the targeted advertising system by improving market penetration of satellite radio as well as introducing a second business model that could increase revenue. Satellite radio may supply two services—a premium pay service that would be commercial-free as it is today, and a free service in which the consumer would be subject to periodic targeted commercials in return for receiving the service. Satellite radio broadcasters would be compensated for the free subscribers by collecting advertising revenue. For example, a free subscriber may be listening to a broadcast channel on an XM radio. At some designated timeslot, several commercials may be played in place of a song. The premium subscribers would continue to hear the song. If the song was 3:00 minutes long, the free subscriber would here 3:00 minutes of commercials. To make sure the free subscriber heard the commercial, the hardware would freeze the user from changing the channels until the commercials finished playing. If the subscriber left the car before the commercials played, the system would play the commercials when the user returned to the car prior to allowing the user to tune in the station again.

Converting over to a digital radio system along with a targeted advertising system could present a compelling business model that may make digital radio a viable product. Switching to a digital radio broadcast would give the radio stations the additional bandwidth needed to stream commercials without affecting their current broadcast. The broadcasters may benefit because they are now able to provide targeted advertising. By using targeted advertising the broadcaster may be able to fit more ads in a given time slot.

Like the method shown in FIGS. 4-6, the sequence diagrams may be encoded in a signal bearing medium, a computer readable medium such as a memory, programmed within a device such as one or more integrated circuits, or processed by a controller or a computer. If the methods are performed by software, the software may reside in a memory resident to or interfaced to the interface unit 110, a communication interface, or any other type of non-volatile or volatile memory interfaced or resident to the storage device 115. The memory may include an ordered listing of executable instructions for implementing logical functions. A logical function may be implemented through digital circuitry, through source code, through analog circuitry, or through an analog source such through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may include any unit that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A system for providing efficient commercial advertising through a broadcast medium comprising:
a primary broadcast stream;
a secondary broadcast stream comprising at least one targeted user presentation stream;
an interface unit, where the interface unit is configured to receive the primary and secondary broadcast streams and where the interface unit is configured to present the targeted user presentation stream based on a user parameter; and
a storage device for storing at least a portion of the secondary broadcast stream.

2. The system of claim 1 where the secondary broadcast stream comprises a targeted user presentation stream.

3. The system of claim 1 where the primary broadcast stream comprises a digital or analog television, satellite television, digital or analog satellite radio, or high-definition television (HDTV) broadcast transmission.

4. The system of claim 1 where the interface unit is selected from the group consisting of: a television cable box, a television antenna receiver unit, a satellite television receiver unit, a vehicle radio and/or entertainment unit, a vehicle telematics unit, a vehicle satellite radio receiver unit, a desktop computer, a laptop computer, a handheld radio unit, handheld satellite reception unit, a wireless Internet receiver, and a portable entertainment unit.

5. The system of claim 1 where the storage device is configured to store at least a portion of the primary broadcast stream.

6. The system of claim 1 where the primary and secondary broadcast streams are presented in real-time or in a time-delayed manner.

7. A method for delivering commercial advertising through a broadcast transmission to an interface unit configured to receive the broadcast transmission comprising the steps of:
receiving a primary broadcast stream;
receiving a secondary broadcast stream;
storing at least a portion of the secondary broadcast stream; and
presenting a targeted user presentation stream based on a user parameter, wherein the targeted user presentation stream is contained within the secondary broadcast stream.

8. The method of claim 7 further comprising the step of storing at least a portion of the primary broadcast stream.

9. The method of claim 7 wherein the step of presenting comprises displaying a visual portion of the targeted user presentation stream on a graphical display; and outputting an audio portion of the targeted user presentation stream via a speaker system.

10. The method of claim 7 further comprising the steps of:
storing at least one user profile comprising the at least one user parameter;
selecting the user profile;
receiving a start marker contained within the primary broadcast stream, wherein the start marker indicates a beginning of a commercial break within the primary broadcast stream;
triggering the interface unit to retrieve a portion of the secondary broadcast stream previously stored;
presenting the targeted user presentation stream during the commercial break if the interface unit is configured to decode the targeted user presentation stream;
presenting a standard commercial stream to the user if the interface unit is not configured to decode the targeted user presentation stream;
receiving a stop marker contained with the primary broadcast stream, wherein the stop marker indicates an end of the commercial break within the primary broadcast stream; and
resuming presentation of the primary broadcast stream after receiving the stop marker.

11. The method of claim 10 wherein the step of storing at least a portion of the secondary broadcast stream comprises storing the targeted user presentation stream only if the targeted user presentation stream matches the user parameter previously stored.

12. The method of claim 7 wherein the user parameter is a user demographics parameter or a ratings preference.

13. The method of claim 12 wherein the user parameter is changed during operation of the interface unit.

14. The method of claim 10 wherein the step of selecting the user profile comprises selecting a preset button on the interface unit or communicating with the interface unit with a wireless device.

15. The method of claim 10 wherein the step of presenting the targeted user presentation stream further comprises presenting the targeted commercial stream only if the targeted commercial stream matches the user parameter previously stored.

16. The method of claim 10 further comprising the step of receiving a time slot header after receiving the start marker, wherein the time slot header indicates the targeted user presentation streams to be played during the commercial break.

17. The method of claim 10 further comprising the steps of:
preventing a user from changing from a first channel to a second channel while a commercial break is in progress, wherein the commercial break lasts from the receipt of the start marker until the receipt of the stop marker;
pausing the presentation of the targeted user presentation stream if the interface unit is shut off during the commercial break; and
resuming the presentation of the targeted user presentation stream when the interface unit is turned on again.

18. The method of claim 10 further comprising the steps of collecting a set of feedback information about user parameters by the interface unit; and sending the user parameter feedback information to a broadcaster of the secondary broadcast stream.

19. The method of claim 18 wherein the method is adapted for use in a vehicle, wherein the set of feedback information is provided by interacting with the interface unit to indicate a user rating preference of the targeted user presentation stream.

20. An apparatus for providing efficient commercial advertising through a broadcast medium comprising:
means for receiving a primary broadcast stream and a secondary broadcast stream;
means for decoding the primary and secondary broadcast streams; and
means for storing at least a portion of the secondary broadcast stream,
wherein the means for decoding is further configured to present a targeted advertisement stream contained within the secondary broadcast stream, and wherein the targeted advertising stream is selected based on a user preference.
